(19) United States
(12) Patent Application Publication
(10) Pub. No.: US 2026/0333427 A1
(43) Pub. Date: Oct. 22, 2026

(54) INDICATING AMOUNT OF DATA WAITING TO BE TRANSMITTED

(71) Applicant: Nokia Technologies Oy, Espoo (FI)

(72) Inventors: Nuno Manuel KIILERICH PRATAS, Aalborg (DK); Oana-Elena BARBU, Aalborg (DK); Benny VEJLGAARD, Gistrup (DK); Johannes HARREBEK, Aalborg (DK); Simon SVENDSEN, Aalborg (DK)

(21) Appl. No.: 19/486,702

(22) PCT Filed: May 3, 2024
(86) PCT No.: PCT/EP2024/062210

§ 371 Date: Nov. 21, 2025

(30) Foreign Application Priority Data
Jul. 6, 2023 (FI) 20235802

(51) Int. Cl. H04W 74/0808; G16Y 30/00

(52) U.S. Cl. CPC H04W 74/0808; G16Y 30/00

(57) ABSTRACT

Disclosed is a method comprising transmitting, by a first device, a first signal comprising at least an identifier of the first device, and information indicating an amount of data waiting to be transmitted at the first device.

### FIELD

The following example embodiments relate to wireless communication.

### BACKGROUND

The number of internet of things (IoT) connections has been growing rapidly in recent years and is predicted to be hundreds of billions in the near future. There is a challenge in how to collect data from IoT devices.

### BRIEF DESCRIPTION

The scope of protection sought for various example embodiments is set out by the claims. The example embodiments and features, if any, described in this specification that do not fall under the scope of the claims are to be interpreted as examples useful for understanding various embodiments.

According to an aspect, there is provided a first device comprising at least one processor, and at least one memory storing instructions that, when executed by the at least one processor, cause the first device at least to: transmit a first signal comprising at least an identifier of the first device, and information indicating an amount of data waiting to be transmitted at the first device.

According to another aspect, there is provided a first device comprising means for transmitting a first signal comprising at least an identifier of the first device, and information indicating an amount of data waiting to be transmitted at the first device.

According to another aspect, there is provided a method comprising: transmitting, by a first device, a first signal comprising at least an identifier of the first device, and information indicating an amount of data waiting to be transmitted at the first device.

According to another aspect, there is provided a computer program comprising instructions which, when executed by a first device, cause the first device to perform at least the following: transmitting a first signal comprising at least an identifier of the first device, and information indicating an amount of data waiting to be transmitted at the first device.

According to another aspect, there is provided a computer readable medium comprising program instructions which, when executed by a first device, cause the first device to perform at least the following: transmitting a first signal comprising at least an identifier of the first device, and information indicating an amount of data waiting to be transmitted at the first device.

According to another aspect, there is provided a non-transitory computer readable medium comprising program instructions which, when executed by a first device, cause the first device to perform at least the following: transmitting a first signal comprising at least an identifier of the first device, and information indicating an amount of data waiting to be transmitted at the first device.

According to another aspect, there is provided a second device comprising at least one processor, and at least one memory storing instructions that, when executed by the at least one processor, cause the second device at least to: receive a first signal comprising at least an identifier of a first device, and information indicating an amount of data waiting to be transmitted at the first device.

According to another aspect, there is provided a second device comprising: means for receiving a first signal comprising at least an identifier of a first device, and information indicating an amount of data waiting to be transmitted at the first device.

According to another aspect, there is provided a method comprising: receiving, by a second device, a first signal comprising at least an identifier of a first device, and information indicating an amount of data waiting to be transmitted at the first device.

According to another aspect, there is provided a computer program comprising instructions which, when executed by a second device, cause the second device to perform at least the following: receiving a first signal comprising at least an identifier of a first device, and information indicating an amount of data waiting to be transmitted at the first device.

According to another aspect, there is provided a computer readable medium comprising program instructions which, when executed by a second device, cause the second device to perform at least the following: receiving a first signal comprising at least an identifier of a first device, and information indicating an amount of data waiting to be transmitted at the first device.

According to another aspect, there is provided a non-transitory computer readable medium comprising program instructions which, when executed by a second device, cause the second device to perform at least the following: receiving a first signal comprising at least an identifier of a first device, and information indicating an amount of data waiting to be transmitted at the first device.

### LIST OF DRAWINGS

In the following, various example embodiments will be described in greater detail with reference to the accompanying drawings, in which

FIG. 1 illustrates an example of a wireless communication network;

FIG. 2 illustrates an example of a clear channel assessment slot;

FIG. 3 illustrates an extended listen-before-talk procedure;

FIGS. 4A, 4B and 4C illustrate a listen-before-talk Type 1 contention window countdown procedure and examples of how it can be disrupted;

FIGS. 5A, 5B, 5C, 5D, 5E and 5F illustrate the allowed gaps for which each listen-before-talk Type 2 variant is applicable;

FIG. 6 illustrates a signal flow diagram;

FIG. 7 illustrates a signal flow diagram;

FIG. 8 illustrates a signal flow diagram;

FIG. 9 illustrates a flow chart;

FIG. 10 illustrates a flow chart;

FIGS. 11A, 11B and 11C illustrate some examples of mapping between a buffer status report index and a backscatter waveform;

FIG. 12 illustrates an example of an apparatus; and

FIG. 13 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Some example embodiments described herein may be implemented in a wireless communication network comprising a radio access network based on one or more of the following radio access technologies: Global System for Mobile Communications (GSM) or any other second generation radio access technology, Universal Mobile Telecommunication System (UMTS, 3G) based on basic wideband-code division multiple access (W-CDMA), high-speed packet access (HSPA), Long Term Evolution (LTE), LTE-Advanced, fourth generation (4G), fifth generation (5G), 5G new radio (NR), 5G-Advanced (i.e., 3GPP NR Rel-18 and beyond), or sixth generation (6G). Some examples of radio access networks include the universal mobile telecommunications system (UMTS) radio access network (UTRAN), the Evolved Universal Terrestrial Radio Access network (E-UTRA), or the next generation radio access network (NG-RAN). The wireless communication network may further comprise a core network, and some example embodiments may also be applied to network functions of the core network.

It should be noted that the embodiments are not restricted to the wireless communication network given as an example, but a person skilled in the art may also apply the solution to other wireless communication networks or systems provided with necessary properties. For example, some example embodiments may also be applied to a communication system based on IEEE 802.11 specifications, or a communication system based on IEEE 802.15 specifications.

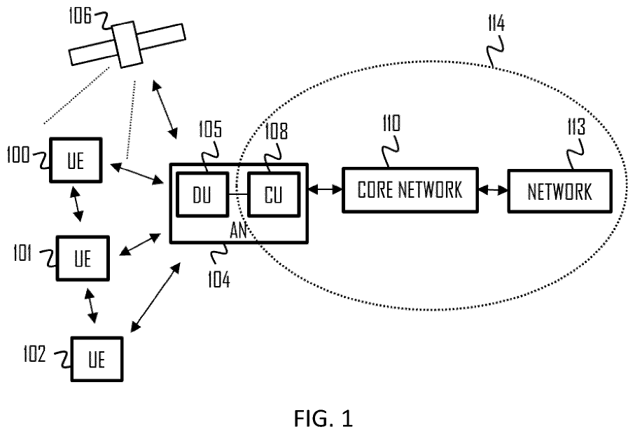

FIG. 1 depicts an example of a simplified wireless communication network showing some physical and logical entities. The connections shown in FIG. 1 may be physical connections or logical connections. It is apparent to a person skilled in the art that the wireless communication network may also comprise other physical and logical entities than those shown in FIG. 1.

The example embodiments described herein are not, however, restricted to the wireless communication network given as an example but a person skilled in the art may apply the embodiments described herein to other wireless communication networks provided with necessary properties.

The example wireless communication network shown in FIG. 1 includes an access network, such as a radio access network (RAN), and a core network 110.

FIG. 1 shows user equipment (UE) 100, 101, 102 configured to be in a wireless connection on one or more communication channels in a radio cell with an access node (AN) 104 of an access network. The AN 104 may be an evolved NodeB (abbreviated as eNB or eNodeB), or a next generation evolved NodeB (abbreviated as ng-eNB), or a next generation NodeB (abbreviated as gNB or gNodeB), providing the radio cell. The wireless connection (e.g., radio link) from a UE to the access node 104 may be called uplink (UL) or reverse link, and the wireless connection (e.g., radio link) from the access node to the UE may be called downlink (DL) or forward link. The UEs 100, 101, 102 may also communicate directly with each other via a wireless connection generally referred to as a sidelink (SL). It should be appreciated that the access node 104 or its functionalities may be implemented by using any node, host, server or access point etc. entity suitable for providing such functionalities.

The access network may comprise more than one access node, in which case the access nodes may also be configured to communicate with one another over links, wired or wireless. These links between access nodes may be used for sending and receiving control plane signaling and also for routing data from one access node to another access node.

The access node may comprise a computing device configured to control the radio resources of the access node. The access node may also be referred to as a base station, a base transceiver station (BTS), an access point, a cell site, a radio access node or any other type of node capable of being in a wireless connection with a UE (e.g., UEs 100, 101, 102). The access node may include or be coupled to transceivers. From the transceivers of the access node, a connection may be provided to an antenna unit that establishes bi-directional radio links to UEs 100, 101, 102. The antenna unit may comprise an antenna or antenna element, or a plurality of antennas or antenna elements.

The access node 104 may further be connected to a core network (CN) 110. The core network 110 may comprise an evolved packet core (EPC) network and/or a 5th generation core network (5GC). The EPC may comprise network entities, such as a serving gateway (S-GW for routing and forwarding data packets), a packet data network gateway (P-GW) for providing connectivity of UEs to external packet data networks, and a mobility management entity (MME). The 5GC may comprise network functions, such as a user plane function (UPF), an access and mobility management function (AMF), and a location management function (LMF).

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

The illustrated UE 100, 101, 102 is one type of an apparatus to which resources on the air interface may be allocated and assigned. The UE 100, 101, 102 may also be called a wireless communication device, a subscriber unit, a mobile station, a remote terminal, an access terminal, a user terminal, a terminal device, or a user device just to mention but a few names. The UE may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, an internet of things (IoT) device, an ambient IoT device, an energy harvesting device, or any computing device comprising a wireless modem integrated in a vehicle.

It should be appreciated that a UE may also be a nearly exclusive uplink-only device, of which an example may be a camera or video camera loading images or video clips to a network. A UE may also be a device having capability to operate in an Internet of Things (IoT) network, which is a scenario in which objects may be provided with the ability to transfer data over a network without requiring human-to-human or human-to-computer interaction. The UE may also utilize cloud. In some applications, the computation may be carried out in the cloud or in another UE.

The wireless communication network may also be able to support the usage of cloud services, for example at least part of core network operations may be carried out as a cloud service (this is depicted in FIG. 1 by “cloud” 114). The wireless communication network may also comprise a central control entity, or the like, providing facilities for wireless communication networks of different operators to cooperate for example in spectrum sharing.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

5G enables using multiple input-multiple output (MIMO) antennas in the access node 104 and/or the UE 100, 101, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine type applications, such as (massive) machine-type communications (mMTC), including vehicular safety, different sensors and real-time control.

In 5G wireless communication networks, access nodes and/or UEs may have multiple radio interfaces, namely below 6 GHz, cmWave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, a 5G wireless communication network may support both inter-RAT operability (such as LTE-5G) and inter-RI operability (inter-radio interface operability, such as below 6 GHz-cmWave-mmWave). One of the concepts considered to be used in 5G wireless communication networks may be network slicing, in which multiple independent and dedicated virtual sub-networks (network instances) may be created within the substantially same infrastructure to run services that have different requirements on latency, reliability, throughput and mobility.

In some example embodiments, an access node (e.g., access node 104) may comprise: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node. The DU 105 may be a logical node hosting radio link control (RLC), medium access control (MAC) and/or physical (PHY) layers of the NR protocol stack for the access node. The operations of the DU may be at least partly controlled by the CU. It should also be understood that the distribution of functions between DU 105 and CU 108 may vary depending on implementation. The CU may comprise a control plane (CU-CP), which may be a logical node hosting the RRC and the control plane part of the PDCP protocol of the NR protocol stack for the access node. The CU may further comprise a user plane (CU-UP), which may be a logical node hosting the user plane part of the PDCP protocol and the SDAP protocol of the CU for the access node.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the access network (e.g., RAN) by utilizing network function virtualization (NFV) and software defined networking (SDN). Using edge cloud may mean access node operations to be carried out, at least partly, in a computing system operationally coupled to a remote radio head (RRH) or a radio unit (RU) of an access node. It is also possible that access node operations may be performed on a distributed computing system or a cloud computing system located at the access node. Application of cloud RAN architecture enables RAN real-time functions being carried out at the access network (e.g., in a DU 105) and non-real-time functions being carried out in a centralized manner (e.g., in a CU 108).

It should also be understood that the distribution of functions between core network operations and access node operations may differ in future wireless communication networks compared to that of the LTE or 5G, or even be non-existent. Some other technology advancements that may be used include big data and all-IP, which may change the way wireless communication networks are being constructed and managed. 5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network, enabling more extensive network coverage. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). A given satellite 106 in the mega-constellation may cover several satellite-enabled network entities that create on-ground cells. The on-ground cells may be created through an on-ground relay access node or by an access node 104 located on-ground or in a satellite.

It is obvious for a person skilled in the art that the access node 104 depicted in FIG. 1 is just an example of a part of an access network (e.g., a radio access network) and in practice, the access network may comprise a plurality of access nodes, the UEs 100, 101, 102 may have access to a plurality of radio cells, and the access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of an access network (e.g., a radio access network), a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of access networks, the concept of “plug-and-play” access nodes may be introduced. An access network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's access network, may aggregate traffic from a large number of Home eNodeBs or Home gNodeBs back to a core network of the operator.

Regarding internet of things (IoT) applications, the 3^{rd} generation partnership project (3GPP) has specified narrowband internet of things (NB-IoT), enhanced machine type communication (eMTC), and NR reduced capability (RedCap) before NR Release 18 to satisfy the requirements on low-complexity and low-power devices for wide-area IoT communication. For example, these IoT devices may consume tens or hundreds of milliwatts of power during transceiving. However, to achieve the internet of everything, IoT devices with even lower power consumption may be needed, for example for applications requiring batteryless devices.

The number of IoT connections has been growing rapidly in recent years and is predicted to be hundreds of billions in the near future. With more and more ‘things’ expected to be interconnected for improving production efficiency and increasing the comforts of life, further reduction of size, complexity, and power consumption may be needed for IoT devices. However, battery replacement for all the IoT devices is impractical due to the tremendous consumption of materials and manpower.

However, energy may be harvested from the environment to power IoT devices for self-sustainable communications, for example in applications with a very large number of devices (e.g., ID tags and sensors). For example, energy may be harvested by collecting solar energy, piezoelectric energy, or radio wave energy. Radio wave energy conversion may be used to collect, for example, radio-frequency identification (RFID), near-field communication (NFC), Bluetooth, 4G, 5G, WiFi, and/or other radio wave energy from the surrounding environment and convert it into electrical energy.

An issue with the current 3GPP technologies is the capability of cooperating with energy harvesting, considering the limited device size. Cellular devices may consume tens or even hundreds of milliwatts power for transceiver processing. Taking an NB-IoT module as an example, the current consumption for receive processing may be approximately 60 milliamperes (mA) with a supply voltage higher than 3.1 volts (V), and 70 mA for transmit processing at 0 decibel-milliwatt (dBm) transmit power. However, the output power provided by an energy harvester may be below 1 milliwatt (mW), considering the small size of a few square centimeters for practical devices. Since the available power may be far less than the consumed power, it may be impractical to power cellular devices directly by energy harvesting in most cases.

One possible solution is to integrate energy harvesting with a rechargeable battery or supercapacitor. However, there are still a few issues to be solved. Firstly, both the rechargeable battery and supercapacitor may suffer from a shortened lifetime in practical cases. It is difficult to provide a constant charging current or voltage by energy harvesting, while long-time continuous charging may be needed due to the very small output power from the energy harvester. An inconstant charging current and long-time continuous charging are harmful to battery life. Furthermore, for a supercapacitor, the lifetime may be significantly reduced in high-temperature environments (e.g., less than 3 years at 50 degrees centigrade).

Secondly, the device size may be significantly increased, if the device is equipped with a battery or supercapacitor. As a small-size button battery can provide a current of just a few tens of milliamperes, a battery with a much larger size (e.g., AA battery) may be needed to power cellular devices. However, the size of such a battery may be even larger than the NB-IoT module itself. To store energy for a proper duration of operation (e.g., one second), the required capacitance of a supercapacitor may be at the level of a hundred milli-farads. The size of such supercapacitors may also be larger than the NB-IoT module itself.

RFID is a technology supporting batteryless tags (devices). The power consumption of commercial passive RFID tags may be as low as 1 microwatt. The key techniques enabling such low power consumption are envelope detection for downlink data reception, and backscatter communication for uplink data transmission. RFID is designed for short-range communications, whose effective range may be less than 10 meters. As the air interface of RFID has remained almost unchanged since 2005, this simple transmission scheme may become an obstacle for improving its link budget and capability of supporting a scalable network.

Backscatter communication is an energy-efficient communication technology for IoT devices, for example. With backscatter communication, the IoT devices may reflect or backscatter an external excitation signal (e.g., power beacon) by tuning a set of antenna impedances. Subsequently, the frequency, phase, and/or amplitude of the excitation signal may be modulated according to the data of these IoT devices. Backscatter communication may enable the IoT devices to transmit their data without active transmission of radio frequency (RF) signals, which results in lower energy consumption. IoT devices and/or other UEs can use backscattering to communicate with their peers and/or relay information to other devices.

There may be three types of backscatter communication systems: monostatic backscatter communication, bistatic backscatter communication, and ambient backscatter communication. In monostatic backscatter communication, the backscattering device (e.g., IoT device) modulates and reflects a dedicated excitation signal (activation signal) that is transmitted by the intended receiver of the data.

In bistatic backscatter communication, the IoT device modulates and reflects a dedicated high-power excitation signal (activation signal) from an RF source (e.g., a base station or a television tower), which is different from the intended receiver.

In ambient backscatter communication, the dedicated high-power excitation signal is replaced by an RF data signal that is intended for other device(s). Hence, ambient backscatter communication does not require the generation of dedicated excitation signals.

Attracted by the low power consumption of backscatter communication, many non-3GPP technologies begin to put efforts into related research, such as WiFi, Bluetooth, ultra-wide band (UWB), and long range (LoRa). Various research shows that a few or tens of microwatts of power consumption can be achieved for passive devices based on or with small modifications to the above air interfaces. For example, a LoRa tag implemented with commercial off-the-shelf components can send its sensing data to the receiver from up to 381 meters away.

A passive radio (passive device) is a device that harvests energy from wireless signals sent on specific carriers and/or bandwidths and charges a simple circuitry that, once activated, emits or reflects a signal, which encodes at least the identifier (ID) of the passive radio. The system architecture around a passive radio may comprise the passive radio, an activator, and a reader.

An activator is a device (e.g., UE or base station or any other wireless communication device) that sends an activation signal targeted at waking up the passive radio.

The passive radio harvests energy over a range of frequencies and listens for activation signals. Once such an activation signal is detected, the passive radio emits or reflects (e.g., by backscattering) a signal which is specific to that radio ID.

A reader is a device (e.g., UE or base station or any other wireless communication device) that listens and detects the passive radio signals. The reader may or may not be collocated with the activator.

In terms of energy storage, the passive radio may be passive or semi-passive. Herein passive refers to batteryless devices with no energy storage capability at all, therefore being completely dependent on the availability of an external source of energy (e.g., used for energy harvesting). Semi-passive refers to devices with limited energy storage capability that do not need to be replaced or recharged manually.

In the context of ambient IoT (AIoT), at least the three following device types may be defined: device type A, device type B, and device type C.

Device type A refers to a passive device (passive radio) with no energy storage and no independent signal generation, but it may use backscattering transmission.

Device type B refers to a passive device (passive radio) with energy storage (e.g., a battery or supercapacitor), but no independent signal generation. Device type B may also use backscattering transmission. Use of the stored energy may potentially include amplification for reflected (backscattered) signals.

Device type C refers to an active device with energy storage and independent signal generation (i.e., active RF component for transmission).

For device type A, the design target for power consumption may be lower than or equal to 10 microwatts. For device type C, the design target for power consumption may be lower than or equal to 1 milliwatt. For device type B, the design target for power consumption may be between the power consumption of device type A and the power consumption of device type C (device A<device B<device C).

For device type A, the complexity design target may be comparable to ultra high frequency (UHF) RFID. For device type C, the complexity design target may be orders of magnitude lower than NB-IoT. For device type B, the complexity design target may be between that of device type A and device type C (device A≤device B≤device C).

In sub-7 gigahertz (GHz) unlicensed bands, the NR coexistence with other systems (e.g., IEEE 802.11) is ensured via a listen-before-talk (LBT) channel access mechanism. In other words, a UE intending to perform a sidelink (SL) transmission needs to first successfully complete an LBT check, before being able to initiate the SL transmission. LBT may also be referred to as clear channel assessment (CCA) or a channel access procedure.

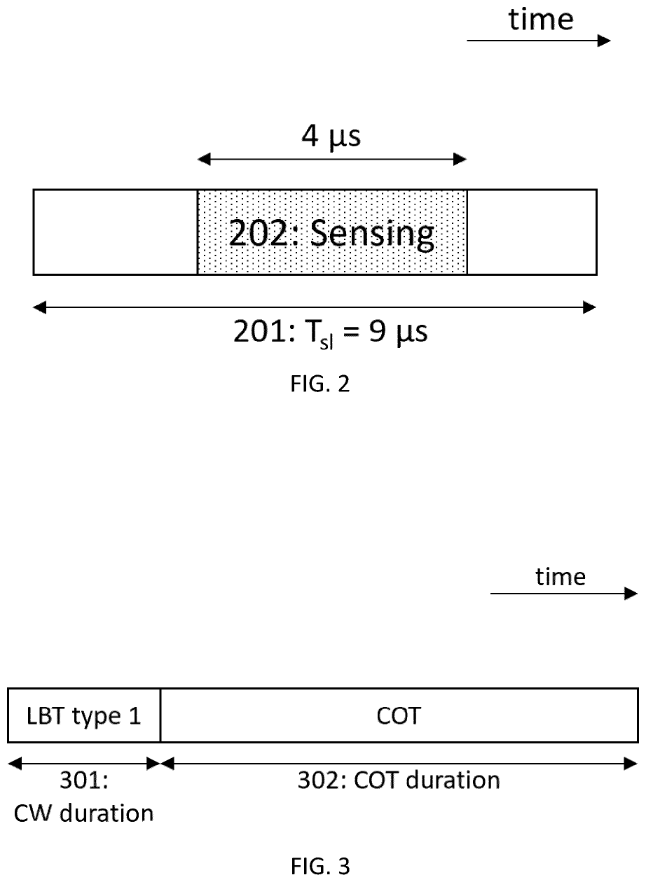

For a UE to pass an LBT check, the UE needs to observe the channel as available for a number of consecutive CCA slots. In sub-7 GHz bands, the duration of these slots may be, for example, 9 microseconds (μs), as depicted in FIG. 2. The UE may deem the channel as available in a CCA slot, if the measured power (i.e., the collected energy during the CCA slot) is below a regulatory-specified threshold (which may depend on the operating band and geographical region).

FIG. 2 illustrates an example of a CCA slot 201 with a duration Tₛₗ=9 μs, where the energy sensing 202 takes place during 4 μs.

When a UE initiates the communication (i.e., the UE takes the role of initiating device), then this UE has to acquire the “right” to access the channel for a certain period of time, denoted in the regulations as the channel occupancy time (COT), by applying an “extended” LBT procedure. This “extended” LBT procedure is also known as LBT Type 1, as specified in TS 37.213.

FIG. 3 illustrates the extended LBT procedure, where the channel needs to be deemed as free for the entire duration of a contention window (CW) 301. In other words, FIG. 3 illustrates the acquisition of the COT 302 by an initiating device via LBT Type 1.

The duration of both the COT and CW depends on the channel access priority class (CAPC) associated with the UE's traffic, as shown in Table 1. Control plane traffic, such as physical sidelink control channel (PSCCH), may be transmitted with p=1, while user plane traffic has p>1. Table 1 depicts the LBT Type 1 details for the Uu uplink (UL) case, but it should be noted that the downlink (DL) case LBT Type 1 parameters could also in principle be adopted in SL. In Table 1, CWₚ denotes the contention window for a given priority class. The contention window length in CCA slots associated with a given CAPC has a minimum (CW_{min,p}) and a maximum (CW_{max,p}). The duration of the COT is given by T_{ulm cot, p}. The parameter mₚ may indicate a number of consecutive sensing slot durations Tₛₗ for calculating a defer time T_{d}. For example, the defer time T_{d} may comprise a duration T_{f}=16 μs followed by mₚ consecutive sensing slot durations Tₛₗ, wherein T_{f} includes an idle sensing slot duration Tₛₗ at the start of T_{f}.

TABLE 1

| Channel | | | | | |
|---|---|---|---|---|---|
| Access | | | | | |
| Priority | | | | | |
| Class | | | | | allowed |
| (p) | mₚ | CW_{min, p} | CW_{max, p} | T_{ulmcot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot, p} = 10 ms if the higher layer parameter absenceOfAnyOtherTechnology-r14 or absenceOfAnyOtherTechnology-r16 is provided, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

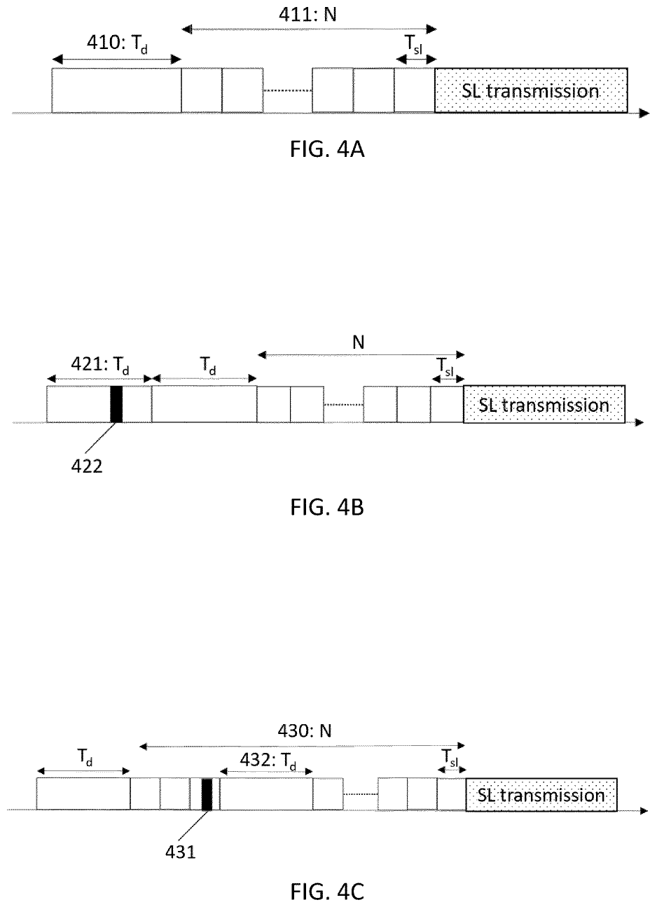

FIGS. 4A, 4B and 4C illustrates the LBT Type 1 contention window countdown procedure and examples of how it can be disrupted. In FIGS. 4A, 4B and 4C, T_{d} refers to the defer time, Tₛₗ refers to the CCA slot duration, and N refers to the number of CCA slots required to be deemed as free before the contention window countdown is complete.

In FIG. 4A, neither the defer time 410 nor the countdown 411 are disrupted (i.e., the channel is not detected as busy during a sensing slot).

In FIG. 4B, the defer time 421 is disrupted due to an interfering transmission 422 (i.e., the channel is detected as busy during the defer time sensing slot 421).

In FIG. 4C, the contention window countdown 430 is disrupted due to an interfering transmission 431 (i.e., the channel is detected as busy during a sensing slot of the countdown 430). Note that if the LBT check fails in any CCA slot during the countdown procedure, then the countdown will stop and it will resume if the channel is deemed as free (i.e., the LBT check is successful) during a defer time 432.

The UE initiating the transmission (the initiating device), upon successfully completing the LBT Type 1 and performing a transmission, acquires the COT with a duration associated with the corresponding CAPC. The acquired COT is valid even in the case where the initiating device pauses its transmission, although if the initiating device wants to perform a new transmission (within the COT) it is still required to perform a “reduced” LBT procedure. This “reduced” LBT procedure is also known as LBT Type 2, as specified in TS 37.213. LBT Type 2 has the following variants: Type 2A, Type 2B, and Type 2C.

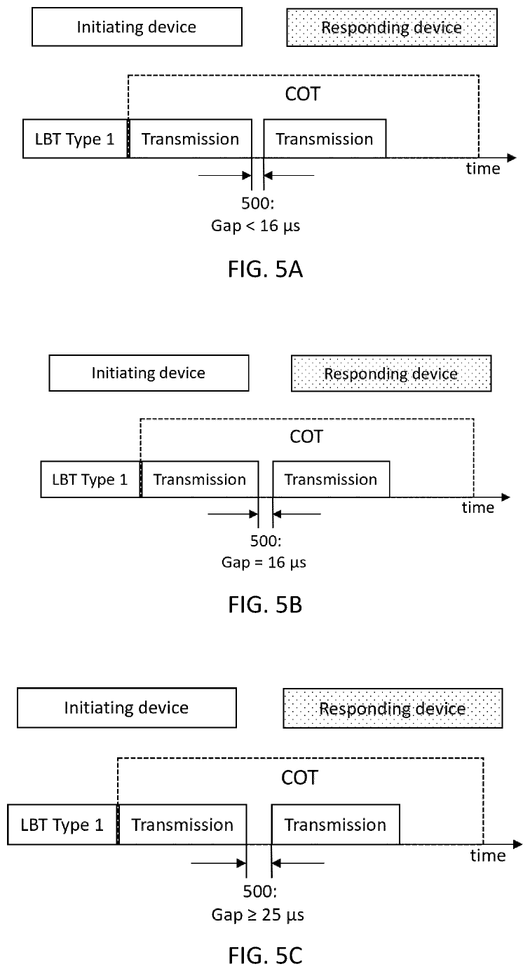

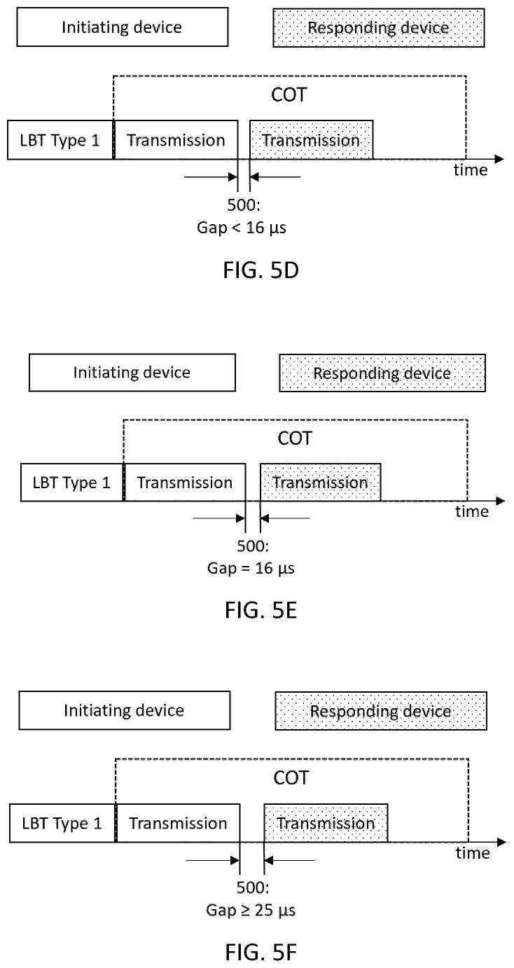

FIGS. 5A, 5B, 5C, 5D, 5E, and 5F illustrate the allowed gaps 500 for which each LBT Type 2 variant is applicable.

LBT Type 2A (25 μs LBT) is for SL transmissions within the COT acquired by the initiating device (in case the gap between two SL transmissions is ≥25 μs, as well for SL transmissions following another SL transmission), depicted in FIGS. 5C and 5F.

LBT Type 2B (16 μs LBT) is for SL transmission within the COT acquired by the initiating device (used for SL transmissions following another SL transmission with a gap equal to 16 μs), depicted in FIGS. 5B and 5E.

LBT Type 2C (no LBT) can be used for SL transmission following another SL transmission, with a gap<16 μs and the allowed duration of the SL transmission≤584 μs, depicted in FIGS. 5A and 5D. For example, in FIG. 5A and FIG. 5D, the LBT Type 2C may take place during the gap 500.

In other words, FIGS. 5A, 5B and 5C show the case where the gap 500 is between two transmissions, which are both from the initiating UE. FIGS. 5D, 5E and 5F show the case where the gap 500 is between two different transmissions from the initiating UE and the responding UE, respectively.

The initiating device may share its acquired COT with its intended receiver (the responding device). For this purpose, the initiating device may inform (e.g., via control signaling) the responding device about the duration of this COT. The responding device may then use this information to decide which type of LBT it should apply upon performing a transmission, for which the intended receiver is the initiating device. In case the transmission of the responding device falls outside the COT, then the responding device will have to acquire a new COT using the LBT Type 1 with the appropriate CAPC.

As mentioned above, any device targeting operation in unlicensed bands (e.g., in 2.4 GHZ, 5 GHz or 6 GHZ) should complete a channel access procedure to coexist with other devices or systems. In case the LBT procedure described above is adopted, it means that the device needs to complete the LBT procedure prior to any transmission.

However, the spectrum access regulations have not yet been updated to reflect if these are applicable to the three types of AIoT devices (device type A, device type B, and device type C) described above. Since the role of the channel access procedure is to enable inter-system coexistence, it can be said that this procedure controls how much time each device occupies the channel for, and consequently the amount of energy emitted by each device. Therefore, the following working assumption can be made for each device type.

For device type A, the LBT procedure may not be applicable, since this device will just modulate the activation signal received from the activator (i.e., perform non-amplified backscattering transmission), and no additional energy is put in the channel.

For device type B, the LBT procedure may be necessary, if the backscattering transmission is amplified. However, since a device type B may not be able to perform LBT by itself, the activator may have to perform LBT Type 1 and then aid the type B device to be able to perform LBT Type 2C (i.e., no LBT). This is possible, since there is no time gap between the activator transmission and the device type B transmission, due to this being a backscattered communication which only occurs when there is an activation signal present.

For device type C, the LBT procedure may be necessary.

An advantage of type C devices over type A and B devices is that the type C devices are able to perform active transmissions, which allow for the support of higher modulation orders and therefore higher throughput, while type A and B devices are restricted to backscattered transmissions, which may have lower order modulations. However, the drawback of type C devices is that in case of high channel activity (intra and inter-system), it is more likely that the LBT procedure will fail, in which case the type C devices would be unable to perform an active transmission.

An AIoT device may transition between device types, for example based on a request from the activator or based on different conditions, such as the expected amount of data traffic to be collected from the AIoT device. However, currently there is no lightweight procedure defined that allows an activator to collect information on the available data traffic from an AIoT device. The available data traffic refers to the data waiting to be transmitted at the AIoT device (e.g., in a buffer).

Some example embodiments may provide such a procedure that allows the activator to acquire information on the data traffic needs from the AIoT device.

Some example embodiments are described below using principles and terminology of 5G radio access technology without limiting the example embodiments to 5G radio access technology, however.

In an example embodiment, the activator may enquire the AIoT device about the amount of data traffic available (i.e., the amount of data waiting to be transmitted) at the AIoT device. This enquiry may be made as if the AIoT device is a type A or type B device. The amount of data waiting to be transmitted at the AIoT device may also be referred to as buffer status report (BSR) information.

A reply mode may then be selected by the AIoT device to provide this information to the activator or reader based on the amount of data available at the AIoT device.

If the there is no data available or the amount of data available can be quantized in a number of predefined states, then the AIoT device may reply as a type A or B device, meaning that the reply is a backscattered transmission, which encodes the AIoT device ID and selected BSR quantized values.

If there is data available and the amount of data available is above the range of the quantized BSR that can be transmitted in a backscattered manner, then the AIoT device may perform an active transmission, which includes the AIoT device ID and an indication of the BSR. For example, this reply may be transmitted in a medium access control (MAC) control element (CE) in a physical uplink shared channel (PUSCH) (for Uu) or a physical sidelink shared channel (PSSCH) (for PC5) resource reserved for that reply.

The activator may provide an activation signal to acquire the data available at the AIoT device. The activation mode (i.e., if the AIoT device should be activated as a type A, B or C device) may be determined based on the received BSR information.

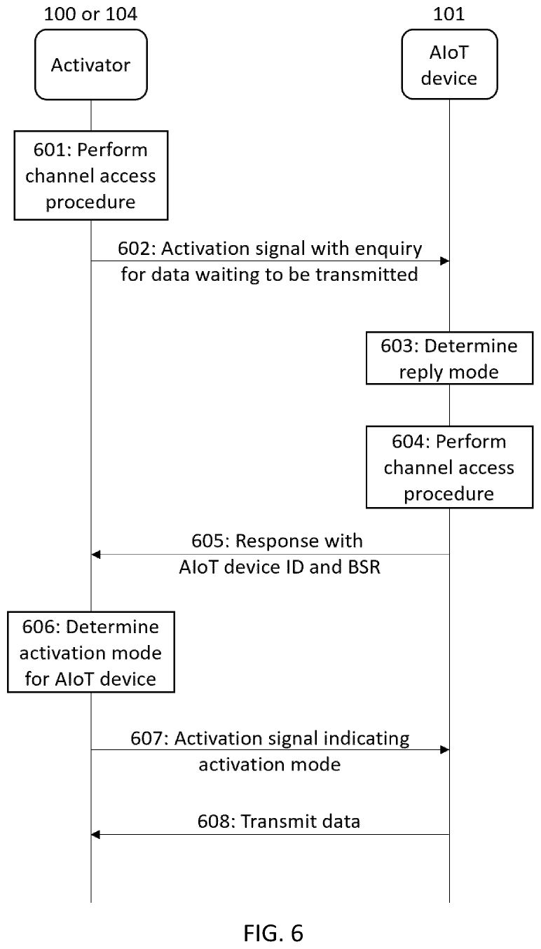

FIG. 6 illustrates a signal flow diagram according to an example embodiment that enables the activator to acquire information about the user plane traffic characteristics of an AIoT device. FIG. 6 illustrates a scenario, where the activator and the reader are collocated (i.e., the activator is also the reader). In other words, this example embodiment applies a monostatic configuration, where the AIoT device performs a direct transmission of its response signal to the activator (instead of a separate reader), wherein this transmission may include the AIoT device ID and the BSR information.

Referring to FIG. 6, at 601, the activator performs a channel access procedure (e.g., see FIGS. 2 to 5 and the description thereof) prior to transmitting an activation signal to an AIoT device 101. The activator may be any type of wireless communication device, for example, a user equipment 100 or a network node 104 or a small cell or a subnetwork of a radio access network. The AIoT device 101 may be able to transition between the device types A, B and C described above.

For example, the channel access procedure may correspond to LBT Type 1, if there is no valid COT. As another example, the channel access procedure may correspond to LBT Type 2, if there is a valid COT.

At 602, upon successfully completing the channel access procedure, the activator transmits, to the AIoT device 101, an activation signal comprising an enquiry for information related to an amount of data waiting to be transmitted at the AIoT device. In other words, the activation signal includes a buffer status report (BSR) request. The activation signal may also include a device type indication of a Type A device. The AIoT device receives the activation signal, and the AIoT device may harvest energy from the activation signal.

The AIoT device may also be referred to as a first device herein, and the activator may also be referred to as a second device herein.

At 603, the AIoT device determines, based at least on the amount of data waiting to be transmitted at one or more buffers of the AIoT device, whether to transmit the response signal by a backscattering transmission or an active transmission. The AIoT device may also determine the contents of the response signal. In other words, upon receiving the activation signal, the AIoT device may determine, for example based on the device type indication, the BSR request and the amount of data available at its buffers, how it should behave for its transmission and which mode (backscattering or active transmission) it should use to provide its response.

For example, when the amount of data available at the AIoT device buffer is 0 or within configured BSR quantized values to be used with backscattered communication, the AIoT device may perform a backscattered transmission that may include at least the requested BSR encoded in the AIoT device ID.

As another example, when the amount of data available at the AIoT device buffer is above the range of the quantized BSR values, the AIoT device may perform an active transmission that may include at least its identifier and the requested BSR information.

The active transmission may refer to a mode of communication, where the AIoT device generates and transmits its own signal using an onboard power source. On the other hand, backscattering is a more passive mode of communication compared to the active transmission.

At 604, the AIoT device may perform a channel access procedure (e.g., LBT procedure of FIGS. 3 to 5) prior to transmitting the response signal.

In case the AIoT device is of device type A or B, the channel access procedure may correspond to LBT Type 2C (i.e., no actual LBT is performed, since there is no gap between the activator signal and the AIoT device response, when the AIoT device performs a backscattered transmission).

Alternatively, in case the AIoT device is of device type C, the channel access procedure may correspond to LBT Type 1 (if there is no valid COT) or LBT Type 2A or 2B (if there is a valid COT).

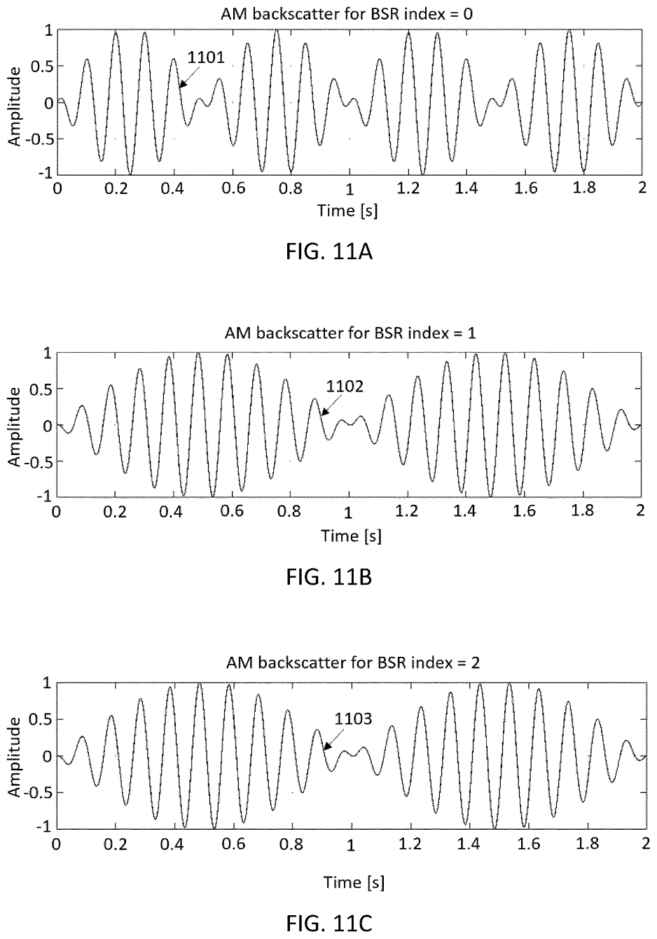

At 605, upon successfully completing the channel access procedure (if it is performed), the AIoT device transmits, to the activator, a response signal comprising at least an identifier of the AIoT device (i.e., AIoT device ID), and information (i.e., BSR information) indicating the amount of data waiting to be transmitted at the AIoT device. For example, the AIoT device ID may be encoded with the quantized BSR information (see FIGS. 11A, 11B and 11C, and the descriptions thereof). The information comprised in the response signal may indicate the amount of data indexed per logical channel of a set of logical channels (i.e., the BSR in the response signal may provide the amount of data available indexed per logical channel). The response signal may further comprise an indication indicating an amount of energy available at the AIoT device. The activator receives the response signal.

The response signal may be transmitted by the backscattering transmission (i.e., device type A or B reply mode) or the active transmission (i.e., device type C reply mode) based on the determination of 603.

The response signal may also be referred to as a first signal herein, and the activation signal of 602 may also be referred to as a second signal herein. In other words, the first signal may be transmitted based on the second signal (e.g., in response to the second signal).

In legacy procedures, the BSR is transmitted from a UE to the network without needing to indicate the UE ID. The reason for this is that the network is the one allocating the UL resource to the UE in the legacy procedures, and therefore only that UE will be able to use those resources. In other words, when the UE uses the allocated UL resources to transmit the BSR, then the network already knows that the BSR is associated with the ID of that UE.

However, in the AIoT setting, it is necessary to include the explicit ID of the AIoT device together with the BSR. The main reason for this is that the activator might on purpose or due to contention activate multiple AIoT devices, and therefore there is a need to distinguish them (e.g., based on the AIoT device ID).

At 606, the activator determines, based on the response signal, a mode of the AIoT device to be applied for transmitting data from the AIoT device. The mode indicates at least whether to transmit the data by a backscattering transmission or an active transmission. The mode may be determined based on at least one of: the amount of data waiting to be transmitted at the AIoT device, or the amount of energy available at the AIoT device.

For example, if the amount of data waiting to be transmitted at the AIoT device is small (e.g., below a threshold), then the activator may determine that the AIoT device should use the backscattering transmission (e.g., to operate as a type A device) for transmitting the data.

As another example, if the amount of data is large (e.g., above the threshold), then the activator may determine that the AIoT device should use the active transmission (e.g., to operate as a type C device) for transmitting the data.

As another example, if the amount of energy available at the AIoT device is small (e.g., below a threshold), then the activator may determine that the AIoT device should use the backscattering transmission (e.g., to operate as a type A device) for transmitting the data.

As another example, if the amount of energy available at the AIoT device is large (e.g., above the threshold), then the activator may determine that the AIoT device should use the active transmission (e.g., to operate as a type C device) for transmitting the data.

At 607, the activator transmits, to the AIoT device, an activation signal (i.e., a second activation signal) indicating the mode of the AIoT device to be applied for transmitting the data from the AIoT device. In other words, the activator provides the activation signal to acquire the data available at the AIoT device, wherein the activation mode (i.e., if the AIoT device should be activated as a type A, B or C device) is determined based on the received BSR information. The AIoT device receives the activation signal, and the AIoT device may harvest energy from the activation signal.

The activation signal of 607 may also be referred to as a third signal herein.

The activation signal of 607 (third signal) may indicate one or more logical channels of the set of logical channels, for which the data should be transmitted. In other words, the activator may target one or more specific logical channels, when requesting the AIoT device to transmit its data, for example by using in the third signal an indication of one or more logical channels, for which the data is allowed to be included in the AIoT device transmission.

At 608, the AIoT device transmits, to the activator, based on the third signal (activation signal of 607), the data waiting to be transmitted at the one or more of buffers of the AIoT device. The transmitted data may correspond to the one or more logical channels that may be indicated in the third signal. The activator receives the data.

Herein the terms “first signal”, “second signal” and “third signal” are used to distinguish the signals, and they do not necessarily mean a specific order of the signals. For example, the second signal (activation signal of 602) may be transmitted prior to the first signal (response signal of 605).

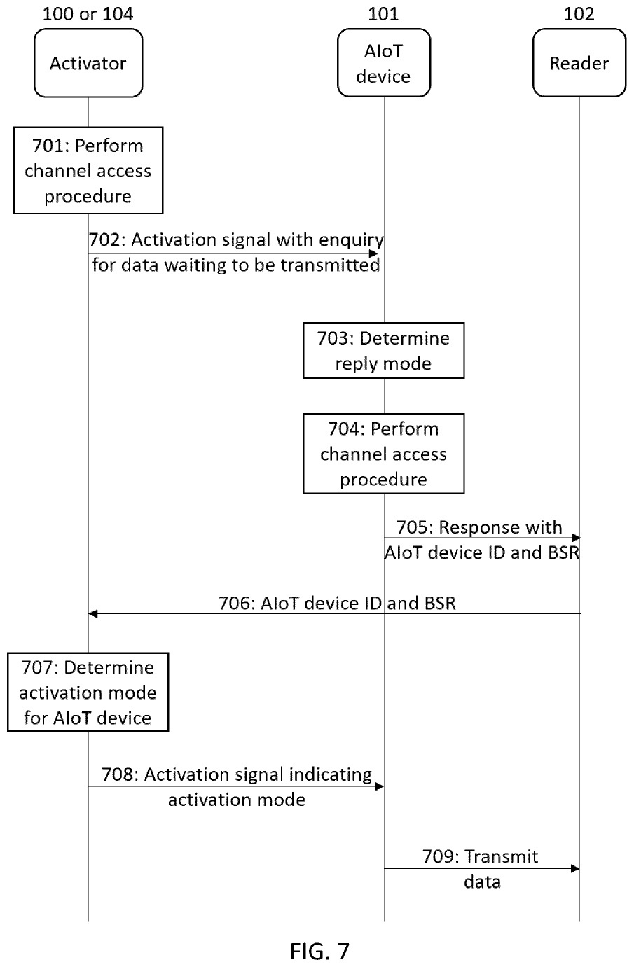

FIG. 7 illustrates a signal flow diagram according to an example embodiment that enables the activator to acquire information about the user plane traffic characteristics of an AIoT device. FIG. 7 illustrates a scenario, where the activator and the reader are not collocated. In other words, this example embodiment applies a bistatic configuration, wherein the AIoT device transmits the response signal to the reader, wherein the response signal includes the AIoT device ID and the BSR information. The reader may then forward the received AIoT device ID and the extracted BSR information to the activator.

Referring to FIG. 7, at 701, the activator performs a channel access procedure prior to transmitting an activation signal to an AIoT device 101. The activator may be any type of wireless communication device, for example, a user equipment 100 or a network node 104 or a small cell or a subnetwork of a radio access network. The AIoT device 101 may be able to transition between the device types A, B and C described above.

For example, the channel access procedure may correspond to LBT Type 1, if there is no valid COT. As another example, the channel access procedure may correspond to LBT Type 2, if there is a valid COT.

At 702, upon successfully completing the channel access procedure, the activator transmits, to the AIoT device, an activation signal comprising an enquiry for information related to an amount of data waiting to be transmitted at the AIoT device. In other words, the activation signal includes a buffer status report (BSR) request. The activation signal may also include a device type indication of a Type A device. The AIoT device receives the activation signal, and the AIoT device may harvest energy from the activation signal.

At 703, the AIoT device determines, based at least on the amount of data waiting to be transmitted at one or more buffers of the AIoT device, whether to transmit the response signal by a backscattering transmission or an active transmission. The AIoT device may also determine the contents of the response signal. In other words, upon receiving the activation signal, the AIoT device may determine, for example based on the device type indication, the BSR request and the amount of data available at its buffers, how it should behave for its transmission and which mode (backscattering or active transmission) it should use to provide its response.

For example, when the amount of data available at the AIoT device buffer is 0 or within configured BSR quantized values to be used with backscattered communication, the AIoT device may perform a backscattered transmission that may include at least the requested BSR encoded in the AIoT device ID.

As another example, when the amount of data available at the AIoT device buffer is above the range of the quantized BSR values, the AIoT device may perform an active transmission that may include at least its identifier and the requested BSR information.

At 704, the AIoT device may perform a channel access procedure (e.g., LBT procedure as explained in the above embodiments) prior to transmitting the response signal.

In case the AIoT device is of device type A or B, the channel access procedure may correspond to LBT Type 2C (i.e., no actual LBT is performed, since there is no gap between the activator signal and the AIoT device response, when the AIoT device performs a backscattered transmission).

Alternatively, in case the AIoT device is of device type C, the channel access procedure may correspond to LBT Type 1 (if there is no valid COT) or LBT Type 2A or 2B (if there is a valid COT).

At 705, upon successfully completing the channel access procedure (if it is performed), the AIoT device transmits, to a reader, a response signal comprising at least an identifier of the AIoT device (i.e., AIoT device ID), and information (i.e., BSR information) indicating the amount of data waiting to be transmitted at the AIoT device. For example, the AIoT device ID may be encoded with the quantized BSR information (see FIGS. 11A, 11B and 11C, and the descriptions thereof). The information comprised in the response signal may indicate the amount of data indexed per logical channel of a set of logical channels (i.e., the BSR in the response signal may provide the amount of data available indexed per logical channel). The response signal may further comprise an indication indicating an amount of energy available at the AIoT device. The reader receives the response signal.

The reader may be any type of wireless communication device, for example, a user equipment 102 or a network node 104 or a small cell or a subnetwork of a radio access network.

The response signal may be transmitted by the backscattering transmission (i.e., device type A or B reply mode) or the active transmission (i.e., device type C reply mode) based on the determination of 703.

The response signal may also be referred to as a first signal herein, and the activation signal of 702 may also be referred to as a second signal herein. In other words, the first signal may be transmitted based on the second signal (e.g., in response to the second signal).

At 706, the reader forwards, to the activator, the information included in the response signal (i.e., at least the identifier of the AIoT device and the information indicating the amount of data waiting to be transmitted at the AIoT device). The activator receives the forwarded information.

At 707, the activator determines, based on the information indicating the amount of data waiting to be transmitted at the AIoT device and/or the amount of energy available at the AIoT device, a mode of the AIoT device to be applied for transmitting data from the AIoT device. The mode indicates at least whether to transmit the data by a backscattering transmission or an active transmission.

For example, if the amount of data waiting to be transmitted at the one or more buffers of the AIoT device is very small (e.g., below a threshold), then the activator may determine that the AIoT device should use the backscattering transmission (e.g., to operate as a type A device) for transmitting the data.

As another example, if the amount of data is large (e.g., above the threshold), then the activator may determine that the AIoT device should use the active transmission (e.g., to operate as a type C device) for transmitting the data.

As another example, if the amount of energy available at the AIoT device is small (e.g., below a threshold), then the activator may determine that the AIoT device should use the backscattering transmission (e.g., to operate as a type A device) for transmitting the data.

As another example, if the amount of energy available at the AIoT device is large (e.g., above the threshold), then the activator may determine that the AIoT device should use the active transmission (e.g., to operate as a type C device) for transmitting the data.

At 708, the activator transmits, to the AIoT device, an activation signal (i.e., a second activation signal) indicating the mode of the AIoT device to be applied for transmitting the data from the AIoT device. In other words, the activator provides the activation signal to acquire the data available at the AIoT device, wherein the activation mode (i.e., if the AIoT device should be activated as a type A, B or C device) is determined based on the received BSR information. The AIoT device receives the activation signal, and the AIoT device may harvest energy from the activation signal.

The activation signal of 708 may also be referred to as a third signal herein.

The activation signal of 708 (third signal) may indicate one or more logical channels of the set of logical channels, for which the data should be transmitted. In other words, the activator may target one or more specific logical channels, when requesting the AIoT device to transmit its data, for example by using in the third signal an indication of one or more logical channels, for which the data is allowed to be included in the data transmission of the AIoT device.

At 709, the AIoT device transmits, to the reader, based on the third signal (activation signal of 708), the data waiting to be transmitted at the AIoT device. The transmitted data may correspond to the one or more logical channels that may be indicated in the third signal. The reader receives the data.

If the final destination of the data is the activator, then the reader may forward the data to the activator. However, if the final destination of the data is the reader, then the reader may not forward the data to the activator.

Herein the terms “first signal”, “second signal” and “third signal” are used to distinguish the signals, and they do not necessarily mean a specific order of the signals. For example, the second signal (activation signal of 702) may be transmitted prior to the first signal (response signal of 705).

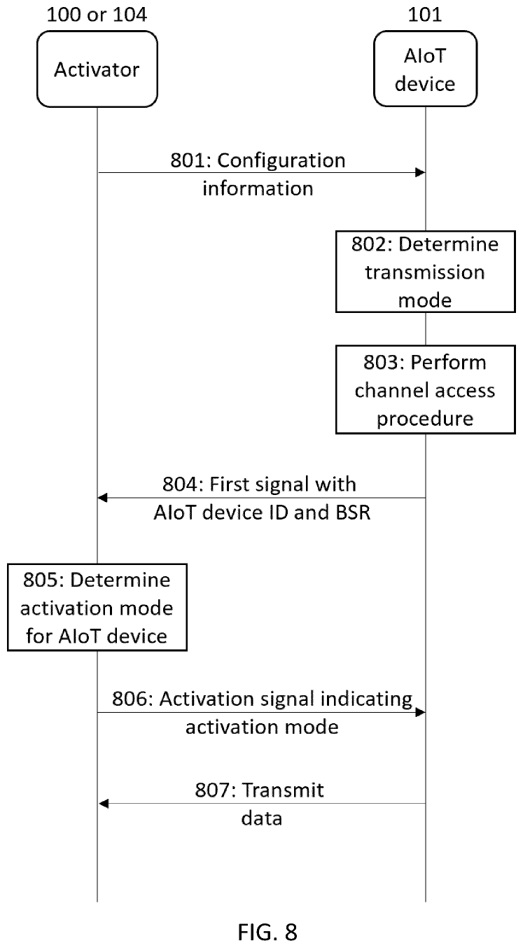

FIG. 8 illustrates a signal flow diagram according to an example embodiment. FIG. 8 illustrates a scenario, where the AIoT device is of fixed type C (e.g., a device required to reliably transfer sensitive data), and the network (e.g., the activator) may pre-configure the AIoT device and/or the reader with a proactive BSR indication transmission and respectively detection.

The BSR information may be encoded into the AIoT device ID that is provided from the AIoT device towards the reader or activator. Most AIoT devices may have a fixed set of data to transmit. Other device types may transmit a dynamic BSR.

Referring to FIG. 8, at 801, the activator transmits, to the AIoT device 101, configuration information indicating one or more radio resources related to a transmission of a first signal comprising the AIoT device ID and the BSR information, and whether the transmission of the first signal is periodic or aperiodic. The radio resources may refer to, for example, physical resource blocks (PRBs) for the transmission of the BSR index.

The activator may be any type of wireless communication device, for example, a user equipment 100 or a network node 104 or a small cell or a subnetwork of a radio access network.

At 802, the AIoT device determines, based at least on the amount of data waiting to be transmitted at one or more buffers of the AIoT device, whether to transmit the first signal by a backscattering transmission or an active transmission.

For example, when the amount of data available at the AIoT device buffer is 0 or within configured BSR quantized values to be used with backscattered communication, the AIoT device may perform a backscattered transmission that may include at least the requested BSR encoded in the AIoT device ID.

As another example, when the amount of data available at the AIoT device buffer is above the range of the quantized BSR values, the AIoT device may perform an active transmission that may include at least its identifier and the requested BSR information.

At 803, the AIoT device may perform a channel access procedure (e.g., LBT procedure as explained in the above embodiments) prior to transmitting the first signal.

In case the AIoT device is of device type A or B, the channel access procedure may correspond to LBT Type 2C (i.e., no actual LBT is performed, since there is no gap between the activator signal and the AIoT device response, when the AIoT device performs a backscattered transmission).

Alternatively, in case the AIoT device is of device type C, the channel access procedure may correspond to LBT Type 1 (if there is no valid COT) or LBT Type 2A or 2B (if there is a valid COT).

At 804, upon successfully completing the channel access procedure (if it is performed), the AIoT device transmits, to the activator, based on the configuration information, the first signal comprising at least the identifier of the AIoT device (i.e., AIoT device ID), and the information (i.e., BSR information) indicating the amount of data waiting to be transmitted at the AIoT device. For example, the AIoT device ID may be encoded with the quantized BSR information (see FIGS. 11A, 11B and 11C, and the descriptions thereof). The information comprised in the first signal may indicate the amount of data indexed per logical channel of a set of logical channels (i.e., the BSR in the first signal may provide the amount of data available indexed per logical channel). The first signal may further comprise an indication indicating an amount of energy available at the AIoT device. The activator receives the first signal.

Alternatively, the AIoT device may transmit the first signal to a reader 102, which may forward the information included in the first signal to the activator (e.g., as shown in FIG. 7).

The first signal may be transmitted by the backscattering transmission (i.e., device type A or B reply mode) or the active transmission (i.e., device type C reply mode) based on the determination of 802.

At 805, the activator determines, based on the information indicating the amount of data waiting to be transmitted at the AIoT device and/or the amount of energy available at the AIoT device, a mode of the AIoT device to be applied for transmitting data from the AIoT device. The mode indicates at least whether to transmit the data by a backscattering transmission or an active transmission.

For example, if the amount of data waiting to be transmitted at the AIoT device is very small (e.g., below a threshold), then the activator may determine that the AIoT device should use the backscattering transmission (e.g., to operate as a type A device) for transmitting the data.

As another example, if the amount of data is large (e.g., above the threshold), then the activator may determine that the AIoT device should use the active transmission (e.g., to operate as a type C device) for transmitting the data.

As another example, if the amount of energy available at the AIoT device is small (e.g., below a threshold), then the activator may determine that the AIoT device should use the backscattering transmission (e.g., to operate as a type A device) for transmitting the data.

As another example, if the amount of energy available at the AIoT device is large (e.g., above the threshold), then the activator may determine that the AIoT device should use the active transmission (e.g., to operate as a type C device) for transmitting the data.

At 806, the activator transmits, to the AIoT device, an activation signal (i.e., a second activation signal) indicating the mode of the AIoT device to be applied for transmitting the data from the AIoT device. In other words, the activator provides the activation signal to acquire the data available at the AIoT device, wherein the activation mode (i.e., if the AIoT device should be activated as a type A, B or C device) is determined based on the received BSR information. The AIoT device receives the activation signal.

The activation signal of 806 may also be referred to as a third signal herein.

The activation signal of 806 (third signal) may indicate one or more logical channels of the set of logical channels, for which the data should be transmitted. In other words, the activator may target one or more specific logical channels, when requesting the AIoT device to transmit its data, for example by using in the third signal an indication of one or more logical channels, for which the data is allowed to be included in the data transmission of the AIoT device.

At 807, the AIoT device transmits, to the activator or to the reader, based on the third signal (activation signal of 806), the data waiting to be transmitted at the AIoT device. The transmitted data may correspond to the one or more logical channels that may be indicated in the third signal. The activator or the reader receives the data.

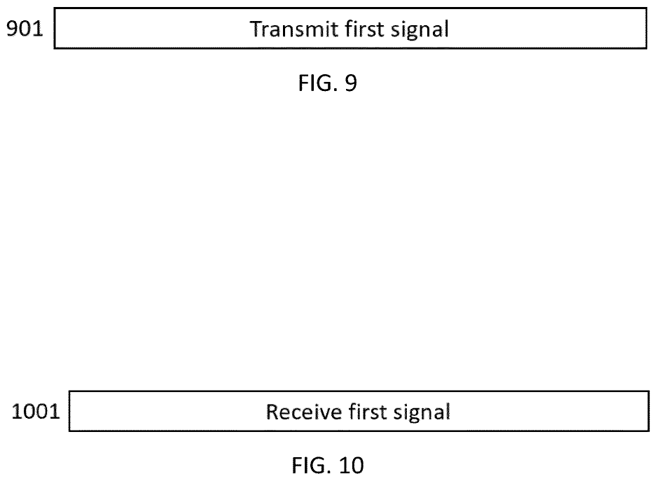

FIG. 9 illustrates a flow chart according to an example embodiment of a method performed by a first device 101. For example, the first device may refer to the AIoT device of FIGS. 6-8, or any other wireless communication device (e.g., UE).

Referring to FIG. 9, in block 901, the first device transmits a first signal comprising at least an identifier of the first device, and information indicating an amount of data waiting to be transmitted at the first device.

For example, the information indicating the amount of data waiting to be transmitted may be encoded into the identifier of the first device in the first signal.

The first signal may further comprise an indication indicating an amount of energy available at the first device.

The first signal may be transmitted to a second device different from the first device. The second device may refer to the activator or reader described above, or any other wireless communication device. For example, the second device may comprise a user equipment 100 or a network node 104 (e.g., gNB) of a radio access network.

The first device may receive (e.g., from the second device) a second signal comprising an enquiry for the amount of data waiting to be transmitted at the first device, wherein the first signal may be transmitted based on the second signal (e.g., in response to the second signal).

Alternatively, the first device may receive, from the second device or a separate network node (e.g., its serving gNB), configuration information indicating one or more radio resources related to a transmission of the first signal, and whether the transmission of the first signal is periodic or aperiodic, wherein the first signal may be transmitted based on the configuration information.

The first device may determine, based at least on the amount of data waiting to be transmitted at the first device, whether to transmit the first signal by a backscattering transmission or an active transmission, wherein the first signal may be transmitted by the backscattering transmission or the active transmission based on the determination.

The first device may perform a channel access procedure prior to transmitting the first signal.

The first device may receive (e.g., from the second device) a third signal indicating a mode of the first device to be applied for transmitting data from the first device, wherein the mode may be determined at the second device based on the first signal, and the mode may indicate at least whether to transmit the data by a backscattering transmission or an active transmission.

The information comprised in the first signal may indicate the amount of data indexed per logical channel of a set of logical channels, and the third signal may further indicate one or more logical channels of the set of logical channels, for which the data should be transmitted.

The first device may transmit, based on the third signal, the data waiting to be transmitted at the first device.

Herein the terms “first signal”, “second signal” and “third signal” are used to distinguish the signals, and they do not necessarily mean a specific order of the signals. For example, the second signal may be received prior to transmitting the first signal.

Similarly, the terms “first device” and “second device” are used to distinguish the devices, and they do not necessarily mean a specific order or specific identifiers of the devices.

FIG. 10 illustrates a flow chart according to an example embodiment of a method performed by a second device. The second device may be, or comprise, or be comprised in, any type of wireless communication device, such as a user equipment 100 or a network node 104 of a radio access network. For example, the second device may refer to the activator or reader described above.

Referring to FIG. 10, in block 1001, the second device receives a first signal comprising at least an identifier of a first device 101 different from the second device, and information indicating an amount of data waiting to be transmitted at the first device. The first signal may be received from the first device 101 or from another device 102.

For example, the information indicating the amount of data waiting to be transmitted may be encoded into the identifier of the first device in the first signal.

The first device 101 may refer to the AIoT device of FIGS. 6-8, or any other wireless communication device (e.g., UE).

The second device may transmit, to the first device, a second signal comprising an enquiry for the amount of data waiting to be transmitted at the first device, wherein the first signal may be received based on transmitting the second signal (e.g., in response to transmitting the second signal).

Alternatively, the second device may transmit, to the first device, configuration information indicating one or more radio resources related to a transmission of the first signal, and whether the transmission of the first signal is periodic or aperiodic, wherein the first signal may be transmitted from the first device based on the configuration information.

The second device may perform a channel access procedure prior to transmitting the second signal or the configuration information.

The first signal may further comprise an indication indicating an amount of energy available at the first device.

The second device may determine, based on the first signal, a mode of the first device to be applied for transmitting data from the first device, and transmit, to the first device, a third signal indicating the mode of the first device to be applied for transmitting the data from the first device. The mode may indicate at least whether to transmit the data by a backscattering transmission or an active transmission.

The information comprised in the first signal may indicate the amount of data indexed per logical channel of a set of logical channels, and the third signal may further indicate one or more logical channels of the set of logical channels, for which the data should be transmitted. The second device may receive the data from the first device.

Herein the terms “first signal”, “second signal” and “third signal” are used to distinguish the signals, and they do not necessarily mean a specific order of the signals. For example, the second signal may be transmitted prior to receiving the first signal.

Similarly, the terms “first device” and “second device” are used to distinguish the devices, and they do not necessarily mean a specific order or specific identifiers of the devices.

The blocks, related functions, and information exchanges (messages) described above by means of FIGS. 6-10 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

FIGS. 11A, 11B and 11C illustrate some examples of mapping between a BSR index and a backscatter waveform 1101, 1102, 1103. The BSR information may be coded onto a BSR index, from a pre-defined set, wherein each index in the set may correspond to a given BSR size in bytes (B). For example, index=0 may correspond to a size=0 B, index=1 may correspond to a size [0, 10B], etc. The AIoT device itself may code the BSR index to a given backscatter waveform 1101, 1102, 1103. That is, for a given BSR index, a unique associated waveform may be generated. For example, BSR index k may be mapped to an amplitude modulation (AM) waveform Aᵢ(t), like shown in FIGS. 11A, 11B and 11C.

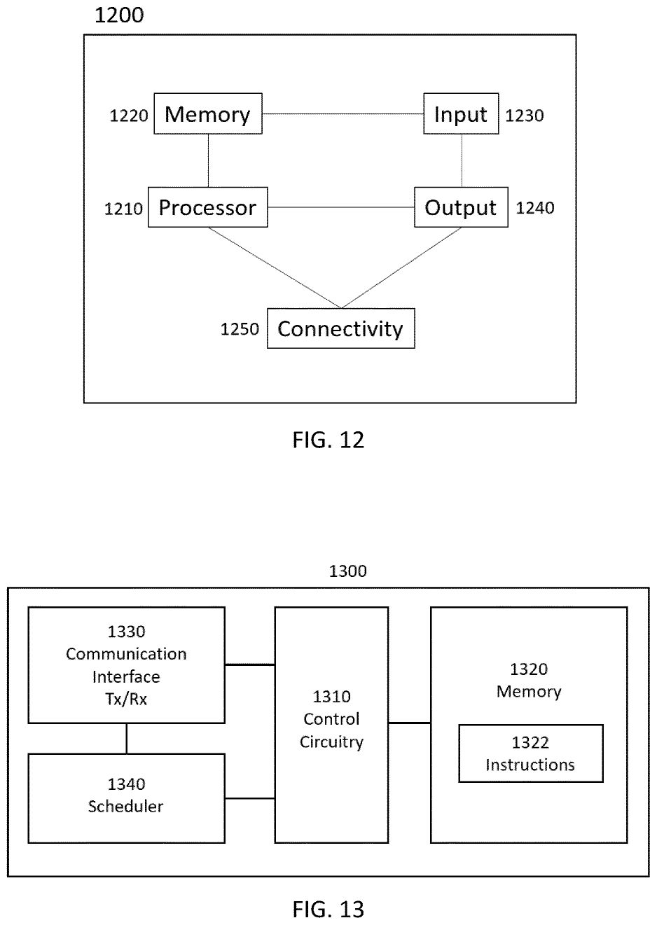

FIG. 12 illustrates an example of an apparatus 1200 comprising means for performing one or more of the example embodiments described above. The apparatus 1200 may refer to the first device (e.g., AIoT device) or second device (e.g., activator or reader) described above. For example, the apparatus 1200 may be an apparatus such as, or comprising, or comprised in, a user equipment (UE) 100, 101, 102. The user equipment may also be called a wireless communication device, a subscriber unit, a mobile station, a remote terminal, an access terminal, a user terminal, a terminal device, a user device, an activator, or an ambient internet of things (AIoT) device.

The apparatus 1200 may comprise a circuitry or a chipset applicable for realizing one or more of the example embodiments described above. For example, the apparatus 1200 may comprise at least one processor 1210. The at least one processor 1210 interprets instructions (e.g., computer program instructions) and processes data. The at least one processor 1210 may comprise one or more programmable processors. The at least one processor 1210 may comprise programmable hardware with embedded firmware and may, alternatively or additionally, comprise one or more application-specific integrated circuits (ASICs).

The at least one processor 1210 is coupled to at least one memory 1220. The at least one processor is configured to read and write data to and from the at least one memory 1220. The at least one memory 1220 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 1220 stores computer readable instructions that are executed by the at least one processor 1210 to perform one or more of the example embodiments described above. For example, non-volatile memory stores the computer readable instructions, and the at least one processor 1210 executes the instructions using volatile memory for temporary storage of data and/or instructions. The computer readable instructions may refer to computer program code.

The computer readable instructions may have been pre-stored to the at least one memory 1220 or, alternatively or additionally, they may be received, by the apparatus, via an electromagnetic carrier signal and/or may be copied from a physical entity such as a computer program product. Execution of the computer readable instructions by the at least one processor 1210 causes the apparatus 1200 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 1200 may further comprise, or be connected to, an input unit 1230. The input unit 1230 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1230 may comprise an interface to which external devices may connect to.

The apparatus 1200 may also comprise an output unit 1240. The output unit may comprise or be connected to one or more displays capable of rendering visual content, such as a light emitting diode (LED) display, a liquid crystal display (LCD) and/or a liquid crystal on silicon (LCoS) display. Alternatively, or additionally, the output unit 1240 may comprise one or more audio outputs. The one or more audio outputs may be for example loudspeakers. However, a simple device such as an AIoT device may not comprise the output unit 1240.

The apparatus 1200 further comprises a connectivity unit 1250. The connectivity unit 1250 enables wireless connectivity to one or more external devices. The connectivity unit 1250 comprises at least one transmitter and at least one receiver that may be integrated to the apparatus 1200 or that the apparatus 1200 may be connected to. The at least one transmitter comprises at least one transmission antenna, and the at least one receiver comprises at least one receiving antenna. The connectivity unit 1250 may comprise an integrated circuit or a set of integrated circuits that provide the wireless communication capability for the apparatus 1200. Alternatively, the wireless connectivity may be a hardwired application-specific integrated circuit (ASIC). The connectivity unit 1250 may also provide means for performing at least some of the blocks or functions of one or more example embodiments described above. The connectivity unit 1250 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1200 may further comprise various components not illustrated in FIG. 12. The various components may be hardware components and/or software components.

FIG. 13 illustrates an example of an apparatus 1300 comprising means for performing one or more of the example embodiments described above. The apparatus 1300 may refer to the second device (e.g., activator or reader) described above. For example, the apparatus 1300 may be an apparatus such as, or comprising, or comprised in, a network node 104 of a radio access network.

The network node may also be referred to, for example, as a network element, a radio access network (RAN) node, a next generation radio access network (NG-RAN) node, a NodeB, an eNB, a gNB, a base transceiver station (BTS), a base station, an NR base station, a 5G base station, an access node, an access point (AP), a cell site, a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1300 may comprise, for example, a circuitry or a chipset applicable for realizing one or more of the example embodiments described above. The apparatus 1300 may be an electronic device comprising one or more electronic circuitries. The apparatus 1300 may comprise a communication control circuitry 1310 such as at least one processor, and at least one memory 1320 storing instructions 1322 which, when executed by the at least one processor, cause the apparatus 1300 to carry out one or more of the example embodiments described above. Such instructions 1322 may, for example, include computer program code (software). The at least one processor and the at least one memory storing the instructions may provide the means for providing or causing the performance of any of the methods and/or blocks described above.

The processor is coupled to the memory 1320. The processor is configured to read and write data to and from the memory 1320. The memory 1320 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1320 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 1320 or, alternatively or additionally, they may be received, by the apparatus, via an electromagnetic carrier signal and/or may be copied from a physical entity such as a computer program product. Execution of the computer readable instructions causes the apparatus 1300 to perform one or more of the functionalities described above.

The memory 1320 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbour cell list, and, in some example embodiments, structures of frames used in the detected neighbour cells.

The apparatus 1300 may further comprise or be connected to a communication interface 1330, such as a radio unit, comprising hardware and/or software for realizing communication connectivity with one or more wireless communication devices according to one or more communication protocols. The communication interface 1330 comprises at least one transmitter (Tx) and at least one receiver (Rx) that may be integrated to the apparatus 1300 or that the apparatus 1300 may be connected to. The communication interface 1330 may provide means for performing some of the blocks for one or more example embodiments described above. The communication interface 1330 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

The communication interface 1330 provides the apparatus with radio communication capabilities to communicate in the wireless communication network. The communication interface may, for example, provide a radio interface to one or more wireless communication devices. The apparatus 1300 may further comprise or be connected to another interface towards a core network such as the network coordinator apparatus or AMF, and/or to the access nodes of the wireless communication network.

The apparatus 1300 may further comprise a scheduler 1340 that is configured to allocate radio resources. The scheduler 1340 may be configured along with the communication control circuitry 1310 or it may be separately configured.

It is to be noted that the apparatus 1300 may further comprise various components not illustrated in FIG. 13. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory (ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways within the scope of the claims. The embodiments are not limited to the example embodiments described above, but may vary within the scope of the claims. Therefore, all words and expressions should be interpreted broadly, and they are intended to illustrate, not to restrict, the embodiments.

1. A first device comprising at least one processor, and at least one memory storing instructions that, when executed by the at least one processor, cause the first device at least to:
transmit a first signal comprising at least an identifier of the first device, and information indicating an amount of data waiting to be transmitted at the first device.

2. The first device according to claim 1, further being caused to:
receive a second signal comprising an enquiry for the amount of data waiting to be transmitted at the first device,
wherein the first signal is transmitted based on the second signal.

3. The first device according to claim 1, further being caused to:
receive configuration information indicating one or more radio resources related to a transmission of the first signal, and whether the transmission of the first signal is periodic or aperiodic,
wherein the first signal is transmitted based on the configuration information.

4. The first device according to any preceding claim, further being caused to:
determine, based at least on the amount of data waiting to be transmitted at the first device, whether to transmit the first signal by a backscattering transmission or an active transmission,
wherein the first signal is transmitted by the backscattering transmission or the active transmission based on the determination.

5. The first device according to any preceding claim, further being caused to:
perform a channel access procedure prior to transmitting the first signal.

6. The first device according to any preceding claim, wherein the first signal further comprises an indication indicating an amount of energy available at the first device.

7. The first device according to any preceding claim, further being caused to:
receive a third signal indicating a mode of the first device to be applied for transmitting data from the first device,
wherein the mode is determined based on the first signal, and the mode indicates at least whether to transmit the data by a backscattering transmission or an active transmission.

8. The first device according to claim 7, wherein the information comprised in the first signal indicates the amount of data indexed per logical channel of a set of logical channels, and
wherein the third signal further indicates one or more logical channels of the set of logical channels, for which the data should be transmitted.

9. The first device according to any of claims 7-8, further being caused to:
transmit, based on the third signal, the data waiting to be transmitted at the first device.

10. A second device comprising at least one processor, and at least one memory storing instructions that, when executed by the at least one processor, cause the second device at least to:
receive a first signal comprising at least an identifier of a first device, and information indicating an amount of data waiting to be transmitted at the first device.

11. The second device according to claim 10, further being caused to:
transmit, to the first device, a second signal comprising an enquiry for the amount of data waiting to be transmitted at the first device,
wherein the first signal is received based on transmitting the second signal.

12. The second device according to claim 11, further being caused to:
perform a channel access procedure prior to transmitting the second signal.

13. The second device according to any of claims 10-12, wherein the first signal further comprises an indication indicating an amount of energy available at the first device.

14. The second device according to any of claims 10-13, further being caused to:
determine, based on the first signal, a mode of the first device to be applied for transmitting data from the first device; and
transmit, to the first device, a third signal indicating the mode of the first device to be applied for transmitting the data from the first device,
wherein the mode indicates at least whether to transmit the data by a backscattering transmission or an active transmission.

15. The second device according to claim 14, wherein the information comprised in the first signal indicates the amount of data indexed per logical channel of a set of logical channels, and
wherein the third signal further indicates one or more logical channels of the set of logical channels, for which the data should be transmitted.

16. A method comprising:
transmitting, by a first device, a first signal comprising at least an identifier of the first device, and information indicating an amount of data waiting to be transmitted at the first device.

17. A method comprising:
receiving, by a second device, a first signal comprising at least an identifier of a first device, and information indicating an amount of data waiting to be transmitted at the first device.

18. A non-transitory computer readable medium comprising program instructions which, when executed by a first device, cause the first device to perform at least the following:
transmitting a first signal comprising at least an identifier of the first device, and information indicating an amount of data waiting to be transmitted at the first device.

19. A non-transitory computer readable medium comprising program instructions which, when executed by a second device, cause the second device to perform at least the following:
receiving a first signal comprising at least an identifier of a first device, and information indicating an amount of data waiting to be transmitted at the first device.
